(19) United States
(12) Patent Application Publication
(10) Pub. No.: US 2013/0181673 A1
(43) Pub. Date: Jul. 18, 2013

(54) CHARGER FOR A BATTERY FOR SUPPLYING POWER TO A DRIVE MOTOR OF A MOTOR VEHICLE

(71) Applicant: Jean-Yves Stineau, Montigny Le Bretonneux (FR)

(72) Inventor: Jean-Yves Stineau, Montigny Le Bretonneux (FR)

(21) Appl. No.: 13/809,731

(22) PCT Filed: Jul. 12, 2011
(86) PCT No.: PCT/FR11/51650

§ 371 Date: Feb. 12, 2013

(30) Foreign Application Priority Data
Jul. 13, 2010 (FR) FR105597

(51) Int. Cl. H02J 7/00

(52) U.S. Cl. CPC H02J 7/0042
USPC 320/109

(57) ABSTRACT

A charger for a drive battery of a motor vehicle, including a high-voltage electrical outlet configured to charge a drive battery of a motor vehicle, and a thermal portion for generating a coolant for the charger and/or for a battery.

The present invention relates to a charger of an energy container of the battery type on an electric motor vehicle. It also relates to a battery recharging station fitted with at least one such energy container.

Certain motor vehicles, such as electric or hybrid vehicles, comprise a battery for powering an electric drive motor. Such a battery needs to be charged regularly since it discharges when it is used.

In order to prevent the vehicle being immobilized while the battery is recharged, it may be of value to exchange this battery when its energy level is low for a new, charged battery. The discharged battery is then recharged for future use. As a variant, the battery may be charged directly on the motor vehicle without being removed.

In all cases, the battery charging phases require a particular installation fulfilling not only the charging function but also other complementary functions. For example, when a battery is charged, it heats up greatly, all the more if this charging is rapid. Thus, it is often recommended to put in place a device for cooling the battery so as not to exceed temperatures that risk damaging it.

The invention relates to the optimization of the charging phases for batteries for driving motor vehicles.

Accordingly, the invention relates to a charger for a battery for driving a motor vehicle, comprising a high-voltage electric outlet suitable for the charging of a battery for driving a motor vehicle, characterized in that it comprises a thermal portion for creating a coolant for the charger and/or for a battery.

The charger for a drive battery may also comprise an outlet suitable for a communication with a battery computer.

It may also comprise a low-voltage electric outlet suitable for electrically powering a battery computer.

It may comprise a supervisor which manages the charging of a battery, the diagnostics of a battery and the cooling of a battery.

It may comprise an Ethernet connector and/or a CAN driver and network connected to the supervisor and suitable for its/their connection to the outside.

It may comprise an electric inlet for powering it electrically.

It may comprise an AC/DC converter connected upstream to the electric inlet and as an outlet to the low-voltage electric outlet.

It may comprise an I/O board connected to the outlet suitable for a communication with a battery computer by various relays that it drives to acquire certain items of analog information, such as the voltage upstream of the charger and the temperature of the outlet air.

It may comprise a first AC/DC converter which supplies a low voltage at the outlet, a second AC/DC converter which supplies a high voltage at the outlet and an I/O board, the aforegoing being connected to a supervisor which drives them via an internal bus.

The thermal portion for creating a coolant for the charger and/or for a battery may comprise a compressor, an air evaporator, a capillary relief valve, and an air condenser for performing the function of a heat pump.

The charger for a battery for driving a motor vehicle may take an integrated form in a single casing.

The casing may comprise some or all of the following components:
a conventional electric power supply;
an Ethernet connector for an Ethernet connection;
a low-voltage electric connector;
a high-voltage electric connector;
an analog connection;
a connection of the CAN network type;
a first terminal for a first thermal connection, of the type to a hot condenser;
a second terminal for a second thermal connection for a cold coolant.

The invention also relates to a battery management station for powering a motor for driving a motor vehicle, characterized in that it comprises at least one charger as described above.

These subjects, features and advantages of the present invention will be explained in detail in the following description of a particular embodiment given in a nonlimiting manner with respect to the appended figures amongst which:

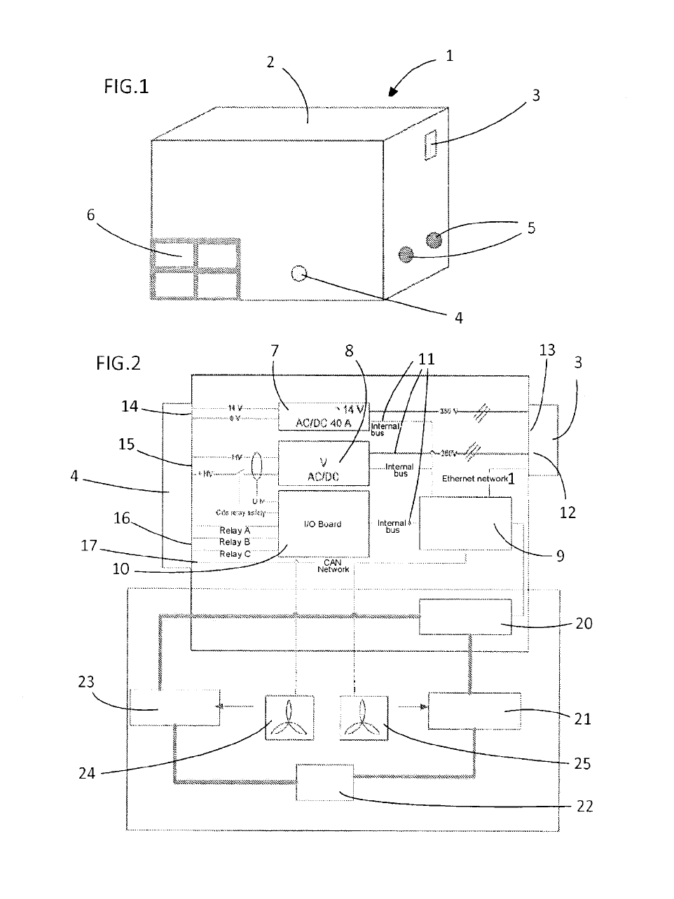

FIG. 1 represents a simplified view in perspective of a battery charger according to one embodiment of the invention.

FIG. 2 represents a functional diagram of the battery charger according to the embodiment of the invention.

The concept of the invention is based on a charger incorporating several functions in one and the same compact device, preferably within one and the same casing, in order to make it easier to carry out a battery-charging phase.

FIG. 1 illustrates such a charger 1 which takes the form of a casing 2 of parallelepipedal shape, with a dimension that may be of the order 100×50×100 centimeters. According to the concept of the invention, this casing 2 groups together in its internal volume the components necessary for carrying out several functions necessary for the charging of a battery. Thus, it comprises a first connection system 3 forming an inlet for the needs of the charger. This first connector system may incorporate a conventional electric power supply and an Ethernet connector for an Ethernet connection. It comprises a second connection system 4 forming an outlet for a connection with a battery. This second connection system 4 may comprise a low-voltage electric connection for the powering of a computer, a high-voltage electric connection for performing the function of charging the battery as such, and an analog connection for receiving data from the battery. The charger 1 also comprises a first terminal 5 for a first thermal connection, for example to a hot condenser, and a second terminal 6 for a second thermal connection, for example for cold air, in order to perform a function of cooling the battery and/or the charger itself. Finally, the charger incorporates certain supplementary functions not visible in FIG. 1.

FIG. 2 details the inputs and outputs mentioned above and represents the various functions incorporated into the charger 1, according to the embodiment of the invention. Naturally, as a variant, the various inputs and/or outputs of the charger 1 could be arranged differently on the casing 2.

In the first place, the charger 1 comprises a first portion called the “electrotechnical portion”. The first connection system 3 comprises a first conventional electric connector 13 for powering a first AC/DC converter 7 which supplies at the output a 14 V voltage and a second AC/DC converter 8 which supplies at the output a 500 V voltage. A supervisor 9 is also connected vai this first connection system 3 to an Ethernet network via an Ethernet connector 12. The second connection system 4 therefore comprises a first connector 14 for a 14 V electric supply, connected to the first AC/DC converter 7, and a second connector 15 for a 500 V electric supply, connected to the second AC/DC converter 8, used for the function of charging the battery and delivering therefor a power of approximately 35 Kw. Finally, the supervisor 9 (in the form of a supervision board) is connected to an analog connection system 16 of the second connection system 4 by means of an I/O (analog and logical inputs/outputs) board 10. The supervisor 9 is also connected to the other components 7, 8, 10 of the charger 1 via internal buses 11 and to the outside via a CAN network and driver 17 in order to communicate with a computer that is present in the battery.

The charger 1 comprises a second portion called the “thermal portion”, which implements the cooling function. For this, it comprises a compressor 20, an air evaporator 21, a capillary relief valve 22, and an air condenser 23 in order to implement the heat-pump function generating cooling for the cooling functions of the charger 1 and/or of a battery. A first fan 24 evacuates the hot air and a second fan 25 circulates the generated cold air. Advantageously, this heat-pump function which is non-reversible, used for the cooling function only, makes it possible to generate cool air at 5° C. minimunm and ventilated at 500 kg/h.

The operation of the charger 1 will now be explained.

The high-voltage electric connection forms a 35 Kw charger for charging a battery. This charging is carried out under the control of the supervisor 9.

The low-voltage power supply is used to power a computer in a drive battery, for example of 400 V, and the other components inside the charger such as the supervisor 9, the I/O board 10, the compressor 20, etc.

The inputs/outputs board drives the various relays of the charger and is used to acquire certain items of analog information, such as the voltage upstream of the charger, the temperature of the air at the output, under the control of the supervisor 9.

The cooler of the heat pump type, of the 2 Kw-power type, is used to cool the battery and to cool the electrotechnical portion of the charger. For this, it operates under the control of the supervisor 9 which controls the set-point temperatures of the battery and of the electrotechnical portion of the charger.

Finally, the supervisor 9 controls all the functions implemented, as mentioned above. In summary, it is used to manage three major functions: the charging and the diagnostics of the battery and the cooling. For this, the supervisor comprises any hardware and software means for carrying out a method for charging, for the diagnostics and for cooling the battery.

Naturally, the functions explained above can be implemented in a similar manner by other technical means. Thus, the cooling can be obtained by any other thermal system representing a means of forming cooling. Moreover, the invention is not limited to the embodiment described and may incorporate simplified versions in which certain preceding functions are removed, for example the cooling function for chargers finding application in assembly plantes or in repair workshops.

The invention also relates to a battery-shcarging station using one or mor chargers as described above.

The solution of the invention finally has the following advantages:
it makes it possible to optimize the charging of a battery and to reduce the costs involved;
it makes it possible to optimally manage the overall energy involved when charging a battery;
it allows a large degree of simplicity and flexibility for the organization of the charging of a battery;
it allows maintenance that is easier and does not immobilize in the event of a failure.

1-13. (canceled)

14. A charger for a battery for driving a motor vehicle, comprising:
a high-voltage electric outlet configured to charge a battery for driving a motor vehicle; and
a thermal portion for creating a coolant for the charger and/or for a battery.

15. The charger for a battery for driving a motor vehicle as claimed in claim 14, further comprising an outlet configured to communicate with a battery computer.

16. The charger for a battery for driving a motor vehicle as claimed in claim 15, further comprising a low-voltage electric outlet configured to electrically power a battery computer.

17. The charger for a battery for driving a motor vehicle as claimed in claim 14, further comprising a supervisor which manages charging of the battery, diagnostics of the battery, and cooling of the battery.

18. The charger for a battery for driving a motor vehicle as claimed in claim 17, further comprising an Ethernet connector and/or a CAN driver and network connected to the supervisor and configured for its/their connection to an outside.

19. The charger for a battery for driving a motor vehicle as claimed in claim 16, further comprising an electric inlet for powering the charger electrically.

20. The charger for a battery for driving a motor vehicle as claimed in claim 19, further comprising an AC/DC converter connected upstream to the electric inlet and as an outlet to the low-voltage electric outlet.

21. The charger for a battery for driving a motor vehicle as claimed in claim 15, further comprising an I/O board connected to the outlet and configured to communicate with the battery computer by relays that it drives to acquire items of analog information, or to acquire a voltage upstream of the charger and a temperature of outlet air.

22. The charger for a battery for driving a motor vehicle as claimed in claim 14, further comprising a first AC/DC converter which supplies a low voltage at the outlet, a second AC/DC converter which supplies a high voltage at the outlet, and an I/O board, the first and second AC/DC converters being connected to a supervisor which drives the AC/DC converters via an internal bus.

23. The charger for a battery for driving a motor vehicle as claimed in claim 14, wherein the thermal portion for creating a coolant for the charger and/or for the battery comprises a compressor, an air evaporator, a capillary relief valve, and an air condenser for performing a function of a heat pump.

24. The charger for a battery for driving a motor vehicle as claimed in claim 14, in an integrated form in a single casing.

25. The charger for a battery for driving a motor vehicle as claimed in claim 24, wherein the casing comprises some or all of the following components:
a conventional electric power supply;
an Ethernet connector for an Ethernet connection;
a low-voltage electric connector;
a high-voltage electric connector;
an analog connection;
a connection of CAN network type;
a first terminal for a first thermal connection, of a type to a hot condenser;
a second terminal for a second thermal connection for a cold coolant.

26. A battery management station for powering a motor for driving a motor vehicle, comprising at least one charger as claimed in claim 14.
